(19) United States
(12) Patent Application Publication
(10) Pub. No.: US 2024/0095452 A1
(43) Pub. Date: Mar. 21, 2024

(54) UNICODE BASED ESTIMATION OF TEXT INTELLIGIBILITY

(71) Applicant: Citrix Systems, Inc., Fort Laudedale, FL (US)

(72) Inventors: Peng Yao, Nanjing (CN); Tianyu Xiao, Nanjing (CN)

(21) Appl. No.: 17/947,248

(22) Filed: Sep. 19, 2022

Related U.S. Application Data
(63) Continuation of application No. PCT/CN2022/119176, filed on Sep. 16, 2022.

(51) Int. Cl. G06F 40/289; G06F 40/126; G06F 40/263

(52) U.S. Cl. CPC G06F 40/289; G06F 40/126; G06F 40/263

(57) ABSTRACT

A system and method for estimating text intelligibility for content provided by a computing resource. A method includes obtaining a text object from a computing resource, the object being configurable for display on at least one client device. Analyzing the text object for intelligibility, including: applying a weight to each character in the text object based on modeled Unicode weights, the modeled Unicode weights being determined from an analysis of a set of domain resources; determining a total weight for the text object based on the weight applied to each character; determining a viability rate for words in the text object; and generating an intelligibility analysis for the text object based on the total weight and viability rate; and effectuating an operational change at the computing resource based on the intelligibility analysis.

### BACKGROUND OF THE DISCLOSURE

Character encoding converts text data into binary numbers that can later be converted back to original characters based on their values. Decoding and displaying text content from a computing resource such as a webpage or app onto a client device is a generally straightforward process since most text content is largely made up of a limited set of standard characters.

### BRIEF DESCRIPTION OF THE DISCLOSURE

Aspects of this disclosure include a system and method for measuring text intelligibility for text content encoded at a computing resource such as a webpage or app.

A first aspect of the disclosure provides a method for estimating text intelligibility for content provided by a computing resource. The method includes obtaining a text object from a computing resource, the object being configurable for display on at least one client device. Analyzing the text object for intelligibility, including: applying a weight to each character in the text object based on modeled Unicode weights, the modeled Unicode weights being determined from an analysis of a set of domain resources; determining a total weight for the text object based on the weight applied to each character; determining a viability rate for words in the text object; and generating an intelligibility analysis for the text object based on the total weight and viability rate. Effectuating an operational change at the computing resource based on the intelligibility analysis.

A second aspect of the disclosure provides a computing system comprising a memory and a processor coupled to the memory and configured to analyze a text object from a computing resource for intelligibility. The process includes: applying a weight to each character in the text object based on modeled Unicode weights, the modeled Unicode weights being determined from an analysis of a set of domain resources; determining a total weight for the text object based on the weight applied to each character: determining a viability rate for words in the text object; and generating an intelligibility analysis for the text object based on the total weight and viability rate. Once generated, effectuating an operational change at the computing resource based on the intelligibility analysis.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts a diagram of a system for measuring text intelligibility, in accordance with an illustrative embodiment.

FIG. 2 depicts Unicode categories, in accordance with an illustrative embodiment.

FIG. 3 depicts a flow diagram of a method of estimating text intelligence, in accordance with an illustrative embodiment.

FIG. 4 depicts a network infrastructure, in accordance with an illustrative embodiment.

FIG. 5 depicts a computing system, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of this disclosure provide technical solutions for estimating text intelligibility for content being provided from a computing resource, such as a web or app server, to a client device. Computing resources commonly provide text content that is encoded and delivered to client devices or the like, which receive, decode and display the text content. For example, a computing resource can include a web server that serves web pages to a browser, or can include an app server that serves apps to remote device. When text content at a client device does not properly decode, the text appears garbled, and the user experience is greatly diminished. There are various reasons why text at a client device will not properly decode, including the fact that there exist numerous character encoding schemes and the client device may not be configured to decode certain types of characters. In other cases, the resource providing the text may include characters that have not been properly encoded to begin with. These problems often become exacerbated when specialized characters are used, such as vulgar fractions (e.g., ¼), special characters (e.g., [symbol] ), etc.

Described embodiments include an intelligibility analysis service that can automatically analyze text content at a computing resource to estimate intelligibility, i.e., a likelihood or measurement that decoding will result in garbled text at a client device. The service accordingly addresses the technical problem of unknowingly creating and/or disseminating content to end users with incorrectly encoded characters or disseminating content that is likely to be incorrectly decoded. In certain aspects, the Unicode encoding standard (Unicode), which provides an encoding for all characters in the world, is utilized to create a model for a domain. The model is then used to evaluate text objects within the domain for intelligibility.

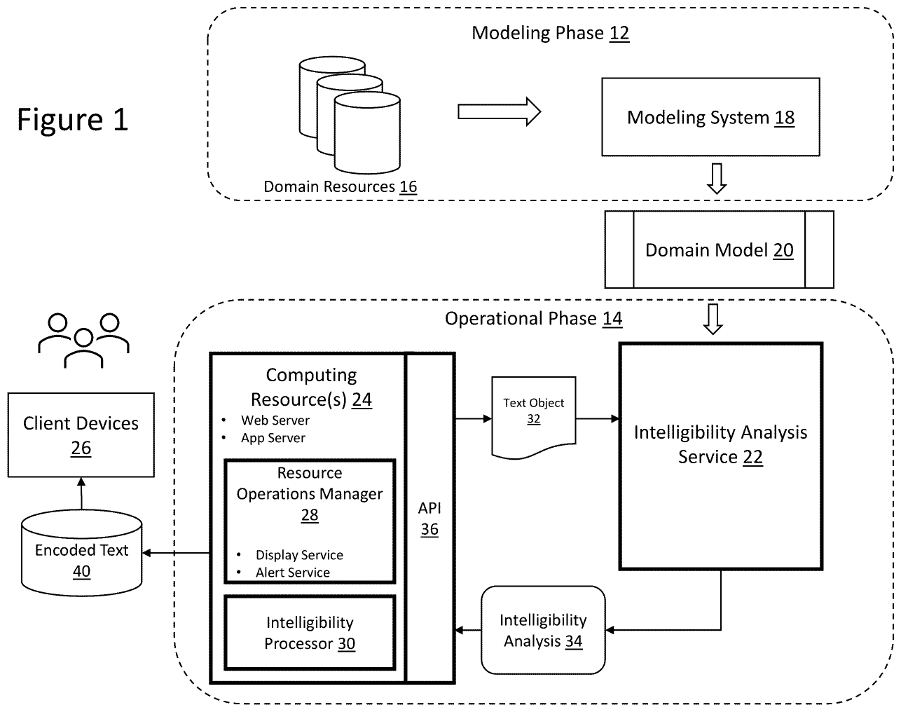

FIG. 1 depicts an illustrative system that depicts a modeling phase 12 and an operational phase 14. The modeling phase 12 includes a modeling system 18 that evaluates domain resources 16 to create a domain model 20. Domain resources 16 may include any data source, e.g., databases, files, documents, web pages, company sales literature, social media posts, technical documents, etc., that includes text content within a particular domain. A domain may include, e.g., a web portal, a business, an industry, a technology area, a social media platform, a field of endeavor, an enterprise, a government agency, an industry, etc.

Different domains will generally have different domain models 20, although related domains could share a common model. Domain models 20 can be created or updated periodically by the modeling system 20, e.g., by crawling resources 16 every month and recalculating the model 20.

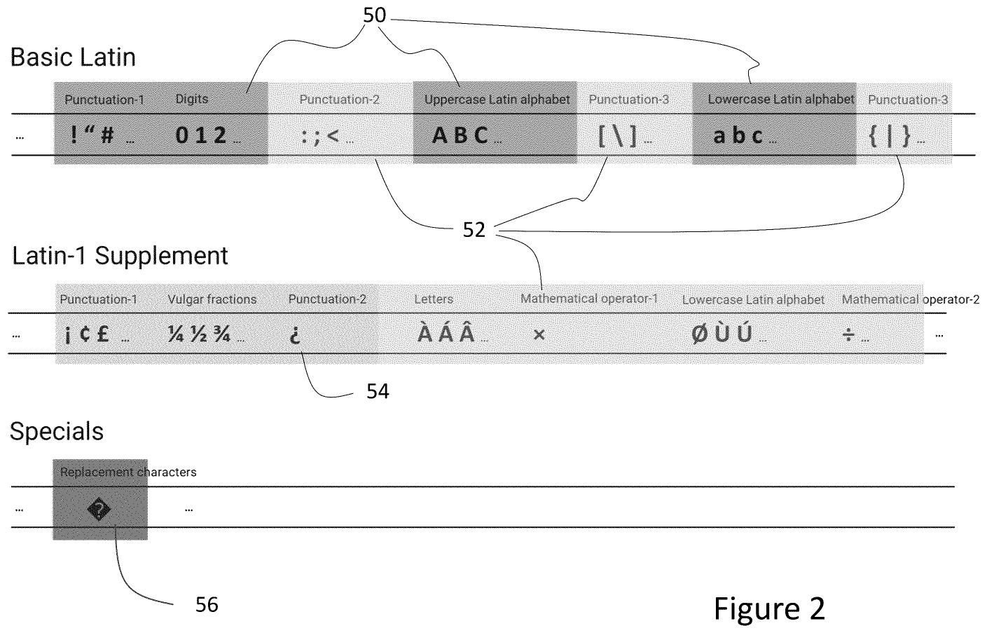

In certain aspects, the modeling system 20 evaluates the frequency (i.e., usage rate) of different characters or categories of characters within resources 16. Based on the frequency, weights are assigned to characters or categories of characters within Unicode to create the domain model 20. For example, categories can include Basic Latin categories, Latin-1 Supplement categories and Special characters. Examples of these are shown in FIG. 2. For example, Basic Latin categories include Punctuation-1, Digits, Punctuation-2, etc. Latin-1 Supplement categories include Punctuation-1, Vulgar fractions, Punctuation-2, etc. Special characters include, e.g., Replacement characters. In one approach, when evaluating domain content resources 16, modeling system 20 determines a relative frequency of characters in each Unicode category and groups the different categories into a predetermined set of tiers. Grouping of categories into tiers can be done in any manner, e.g., by clustering categories with similar usage rates.

For example, modeling system 10 may generate four tiers, including a first tier 50 that includes categories with very high usage, a second tier 52 that includes categories with high usage, a third tier 54 that includes categories with low usage, and a fourth tier 56 that includes categories with a very low usage. In one illustrative embodiment, a very high usage tier may include a set of categories that account for 70% of all the characters in the domain resources 16 (FIG. 1); a high usage tier may include categories that account for 20% of all the characters in the domain resources 16; a low usage tier may include categories that account for 8% of all the characters in the domain resources 16; and a very low usage tier may include categories that account for 2% of all the characters in the domain resources 16.

Once all the categories have been assigned to a tier, a weight is assigned to each tier. For example, and initial weighting may be provided as follows:
Tier 1=1.0
Tier 2=0.5
Tier 3=−0.5
Tier 4=−1
   Weights may thereafter be optimized for the particular domain, e.g., based on relative frequencies of characters in the different tiers, etc. In further embodiments, a machine learning algorithm can be utilized to analyze text from domain resources 16, determine an optimized number of tiers, and optimize weights for each tier, e.g., using K-means clustering.

Referring again to FIG. 1, once a domain model 20 is created, it can be used during the operational phase 14 to evaluate text objects 32. A text object may include any collection or set of textual information, e.g., a sentence, a paragraph, a phrase, a title, a file, a folder of files, a web page, a manual, chat, social media content, work product, etc. In this example, text objects 32 are maintained and/or provided by computing resource(s) 24. When requested, text objects 32 are outputted and delivered as encoded text 40 to client devices 26, e.g., in webpages via a web server, in apps via an app server, etc. In a typical case, content provided by the computer resource 24 is associated with the domain upon which the domain model 20 was built.

In this illustrative embodiment, an intelligibility analysis service 22 obtains a text object 32 (e.g., a block of text) from the computing resource 24 via an application programming interface (API) 36 and utilizes the domain model 20 to generate an intelligibility analysis 34. Intelligibility analysis 34 may for example include a score, a function, a software agent, or some other indication of how likely the text object 32 will appear garbled by the client devices 26. In many cases, the text object 32 would be different from content analyzed in the domain resources 16, e.g., it may include previously unused text content from a new webpage or new app.

In certain embodiments, intelligibility analysis 34 is fed back to the computing resource 24 via API 36 for evaluation by intelligibility processor 30. For example, intelligibility processor 30 may utilize thresholds to determine if some action needs to be taken, e.g., if the analysis 34 includes a score, the score can be compared to one or more values to, e.g.: take no action, take action 1, take action 2, etc. In certain aspects, a resource operations manager 28 may be utilized to effectuate an operational change in the resource 24, e.g., display a message to the client devices 26 via a display service such as “If content appears corrupted, consider adjusting your browser settings as follows.”, or issue an alert condition to a resource administrator via an alert service, such as “Text content being outputted contains a high number of special characters that are unusual for this domain.”

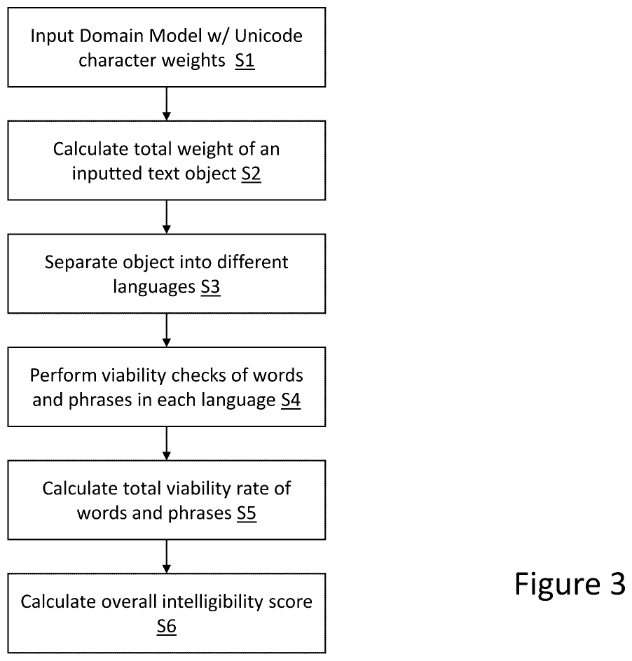

FIG. 3 depicts an illustrative process for implementing intelligibility analysis service 22. Initially, at S1, a domain model 20 is inputted, which includes Unicode character weights specific for a domain. At S2, a total weight of an inputted text object 32 is calculated. In one approach, service 22 applies a value to each character in the text object 32 based on the domain model 20. For example, if a character falls into tier 1 (i.e., the character falls into the very high frequency category), a value of 1.0 is assigned to the character. If a character falls into tier 2 (i.e., the character falls into the high frequency category), a value of 0.5 is assigned to the character, etc. A total weight is then determined for the object 32 by calculating an average value for all the characters in the object 32. For example, consider the following object 32 that includes both English and Chinese characters.
Just like parents are naturally better at washing the dishes, right? No. Come on.
[symbol] [symbol] [symbol] ? [symbol]
   In this case, there are 79 Basic Latin English characters, 19 CJK Unified Ideographs (Chinese characters), two Halfwidth and Fullwidth Form characters: 2 (, ?), and one CJK Symbol and Punctuation character (∘). In this case, all of the characters have a weight of 1.0, so the average, i.e., total weight for the object is 1.0.

Next, at S3, the text object 32 is separated into different languages (if multiple languages are used in the object). Different languages can be identified in any manner, e.g., by analyzing Unicode values of characters in the object 32. Next, at S4, viability checks of words and phrases are determined for each language, i.e., does a randomly selected character belong to a viable word or phrase? For example, in the English portion of the above text, a predetermined number of random checks are done, e.g., 11.
Just like parents are naturally better at washing the dishes, right? No. Come on.
   In each check, a random character is selected, and the service 22 looks at the adjacent characters before and after the selected character and judges whether the set of characters can form a word or phrase. For each iteration, a judgment value is assigned. For example, in a simple case, an arbitrary value (for example 1.0) means success and another arbitrary value (for example −1.0) means failure. The results are processed (for example, averaged) to provide a viability rate. In the above case, the viability rate for the English portion is 1.0.

For the Chinese text portion, the sentence is split with “/” s.
[symbol] [symbol] , [symbol] ? [symbol]
   Again, a number of characters (in this example, 11 characters) are formulaically selected (for example, randomly selected) and judged for word or phrase viability. In this example of Chinese text, the Chinese viability rate is 0.45. Judging the viability of words and phrases can be done in any manner, e.g., using a machine learning to see if a valid word can be predicted.

Next, at S5, a total viability rate is calculated. In one approach, the total viability score is calculated by (1) multiplying viability rates of each language by the number of words in the language, (2) summing the results, and (3) dividing by the total number of words in the entire sentence. The above example would have the following total viability rate:

(1×14+0.45×19)/(14+19)=0.68

One skilled in the art will recognize that other methods of calculating a viability rate may be used.

At S6, an overall intelligibility score is provided by adding the total weight (step S2) with the total viability rate (step S5). In this example, the total intelligibility score is 1.0+0.56=1.68.

The following example involves a text object with uncommon characters:
å½“åœ-¶é-′3æœ\hat{ }3æ-¥¼
   In this example, when analyzed in view of the domain model 20, it is determined that:
The very high frequency tier (1.0) includes characters: “3
The high frequency tier (0.5) includes characters: åœ°é-′æ\hat{ }¥
The low frequency tier (−0.5) includes characters: ½ ¼°¶ ï
The very low frequency tier (−1.0) includes characters: (none).
   The total weight for the object is ((1×2)+(0.5×8)+(−0.5)×5)/15=0.23. The viability rate would be −1.0, as no randomly selected character would result in a viable word or phrase. The overall intelligibility score would be 0.23+(−1)=−0.77.

As is evident, in these examples, the lower the intelligibility score, the less likely the sentence is to understand. When the score is negative, the intelligibility processor 30 (FIG. 1) could automatically determine that sentence likely contains garbled text or will decode as garbled text and cause the resource operations manager 28 to take appropriate action at the computing resource 24.

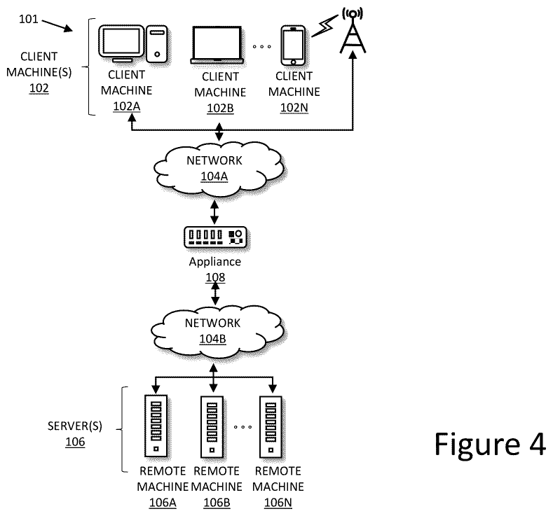

It is understood that the described system can be implemented using any computing technique, e.g., as a stand-alone system, a distributed system, within a network environment, etc. Referring to FIG. 4, a non-limiting network environment 101 in which various aspects of the disclosure may be implemented includes one or more client machines 102A-102N, one or more remote machines 106A-106N, one or more networks 104A, 104B, and one or more appliances 108 installed within the computing environment 101. The client machines 102A-102N communicate with the remote machines 106A-106N via the networks 104A, 104B.

In some embodiments, the client machines 102A-102N communicate with the remote machines 106A-106N via an intermediary appliance 108. The illustrated appliance 108 is positioned between the networks 104A, 104B and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104A and/or 104B.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client machine 102 may have the capacity to function as both a client node seeking access to resources provided by a server 106 and as a server 106 providing access to hosted resources for other client machines 102A-102N. The networks 104A, 104B may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client machine 102.

In yet other embodiments, a server 106 may execute a virtual machine providing, to a user of a client machine 102, access to a computing environment. The client machine 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network; and a primary private network 104. Additional embodiments may include a network of mobile telephone networks that use various protocols to communicate among mobile devices. For short range communications within a wireless local-area network (WLAN), the protocols may include 802.11, Bluetooth, and Near Field Communication (NFC).

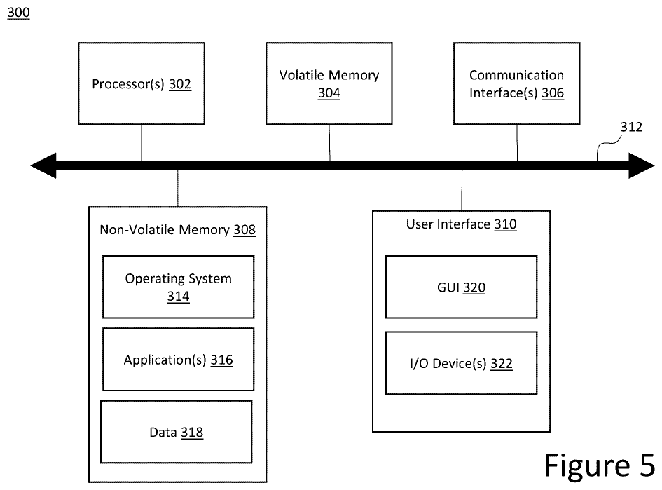

Elements of the described solution may be embodied in a computing system, such as that shown in FIG. 5 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 5 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A computerized method, comprising:
obtaining a text object from a computing resource, the object being configurable for display on at least one client device;
analyzing the text object for intelligibility, including:
applying a weight to each character in the text object based on modeled Unicode weights, the modeled Unicode weights being determined from an analysis of a set of domain resources;
determining a total weight for the text object based on the weight applied to each character;
determining a viability rate for words in the text object; and
generating an intelligibility analysis for the text object based on the total weight and viability rate; and
effectuating an operational change at the computing resource based on the intelligibility analysis.

2. The method of claim 1, wherein the computing resource includes at least one of a web server or an app server.

3. The method of claim 1, wherein the modeled Unicode weights are determined with a machine learning algorithm.

4. The method of claim 1, wherein the modeled Unicode weights include:
a first weight assigned to a first set of Unicode characters determined to have a first usage rate;
a second weight assigned to a second set of Unicode characters determined to have a second usage rate;
a third weight assigned to a third set of Unicode characters determined to have a third usage rate; and
a fourth weight assigned to a fourth set of Unicode characters determined to have a fourth usage rate.

5. The method of claim 1, wherein the total weight of the text object is an average of all weights applied to the characters in the text object.

6. The method of claim 1, wherein the viability rate for words in the text object is determined by:
randomly selecting a set of characters in the text object;
evaluating characters adjacent each selected character to judge whether a word or phrase can be formed using each selected character;
generating the viability rate based on a number of selected characters that are judged to form words or phrases.

7. The method of claim 1, wherein the intelligibility analysis includes:
determining each language used in the text object; and
calculating a separate viability rate for each language.

8. The method of claim 1, wherein the operational change effectuating at the computing resource includes altering a display output to the at least one client device to inform a user of a potential intelligibility issue.

9. The method of claim 1, wherein the operational change effectuating at the computing resource includes outputting an alert condition to an administrator of the computing resource.

10. The method of claim 1, wherein the set of domain resources share a common domain with the computing resource, the common domain being selected from a group consisting of: a web portal, a business, an industry, a technology area, a social media platform, a field of endeavor, an enterprise, a government agency, and an industry.

11. A computing system, comprising:
a memory; and
a processor coupled to the memory and configured to analyze a text object from a computing resource for intelligibility according to a process that includes:
applying a weight to each character in the text object based on modeled Unicode weights, the modeled Unicode weights being determined from an analysis of a set of domain resources;
determining a total weight for the text object based on the weight applied to each character;
determining a viability rate for words in the text object;
generating an intelligibility analysis for the text object based on the total weight and viability rate;
effectuating an operational change at the computing resource based on the intelligibility analysis.

12. The system of claim 11, wherein the computing resource includes at least one of a web server or an app server.

13. The system of claim 11, wherein the modeled Unicode weights are determined with a machine learning algorithm.

14. The system of claim 11, wherein the modeled Unicode weights include:
a first weight assigned to a first set of Unicode characters determined to have a first usage rate;
a second weight assigned to a second set of Unicode characters determined to have a second usage rate;
a third weight assigned to a third set of Unicode characters determined to have a third usage rate; and
a fourth weight assigned to a fourth set of Unicode characters determined to have a fourth low usage rate.

15. The system of claim 11, wherein the total weight of the text object is an average of all weights applied to the characters in the text object.

16. The system of claim 11, wherein the viability rate for words in the text object is determined by:
randomly selecting a set of characters in the text object;
evaluating characters adjacent each selected character to judge whether a word or phrase can be formed using each selected character; and
generating the viability rate based on a number of selected characters that are judged to form words or phrases.

17. The system of claim 11, wherein determining the viability rate includes:
determining each language used in the text object; and
calculating a separate viability rate for each language.

18. The system of claim 11, wherein the operational change effectuating at the computing resource includes altering a display output to at least one client device to inform a user of a potential intelligibility issue.

19. The system of claim 11, wherein the operational change effectuating at the computing resource includes outputting an alert condition to an administrator of the computing resource.

20. The system of claim 11, wherein the set of domain resources share a common domain with the computing resource, the common domain being selected from a group consisting of: a web portal, a business, an industry, a technology area, a social media platform, a field of endeavor, an enterprise, a government agency, and an industry.
